(19) United States
(12) Patent Application Publication
(10) Pub. No.: US 2008/0093017 A1
(43) Pub. Date: Apr. 24, 2008

(54) WARP-FREE DECORATIVE ARTICLE OF MANUFACTURE AND METHOD OF MAKING SAME

(76) Inventor: Phillip J. Young, La Crosse, WI (US)

Correspondence Address: Intellectual Property Department;DEWITT ROSS & STEVENS S.C., US Bank Building, 8000 Excelsior Drive, Suite 401, Madison, WI, 53717-1914, US

(21) Appl. No.: 11/877,161

(22) Filed: Oct. 23, 2007

Related U.S. Application Data
(60) Provisional application No. 60/854,175, filed on Oct. 24, 2006.

(51) Int. Cl. B29D 31/00

(52) U.S. Cl. 156/242

(57) ABSTRACT

The present invention is directed to warp-free decorative articles of manufacture and methods for making the same. Specifically, the present invention is directed to a method of producing a warp-free architectural decorative article of manufacture using cold casting techniques. The method includes pre-applying a substrate with adhesive; bonding the substrate to the out of mold surface of casting while the casting is still in the cavity side of the mold to form a cold cast article of manufacture; conveying the article of manufacture bonded to the substrate to a flat press; applying pressure to the complete package as a whole to achieve intimate contact between pressure sensitive adhesive, backer of choice, and cold cast decorative article of manufacture; filling the resin with metal fillers and or pigments of choice; and allowing the filled resin to cure on the out of mold cavity side of casting. This is the side that is exposed to air.

### REFERENCE TO RELATED APPLICATION

The application claims priority to U.S. Provisional Application entitled “WARP-FREE DECORATIVE ARTICLE OF MANUFACTURE AND METHOD OF MAKING SAME,” Ser. No. 60/854,175, filed Oct. 24, 2006, which is incorporated herein by reference in its entirety.

### FIELD OF THE INVENTION

The present invention is directed to warp-free decorative articles of manufacture and methods for making the same. Specifically, the present invention is directed to a method of producing a warp-free architectural decorative article of manufacture using cold casting techniques.

### DESCRIPTION OF THE PRIOR ART

Prior applications of cold cast resin to an aluminum substrate have always been with a great degree of warp after being fully cured. The aluminum adhesion to cold cast decorative article of manufacture was obtained only with mechanical bonding through surface abrasion to the raw aluminum surface while using what is called a tie coat of resin to bond the two together. Other substrates required a precoating of polyester resin and to cure almost fully before they were also bonded with a tie coat layer of resin. This resin bonded with the other layers/coatings by what is called molecular cross-linking. All of these layers then shrunk together thus pulling on the substrate in which it was bonded to, causing part to warp after total cure.

### SUMMARY OF THE INVENTION

The present invention is directed to a method of producing a warp free decorative article of manufacture using a mold, wherein the mold includes a surface area further comprising relief areas within the surface area, comprising pouring a cold cast resin mixture into the surface area of the mold; allowing the cold cast resin mixture to dry; curing the resin mixture on the mold to form a cold cast resin product; applying an adhesive to a substrate backing to form an adhesive covered substrate; applying the adhesive covered substrate to the resin product; applying pressure to the adhesive covered substrate and the resin product; and removing the warp free decorative article from the mold.

The present invention is also directed to a method of producing a warp free decorative article of manufacture using a mold, wherein the mold includes a surface area further comprising relief areas within the surface area, comprising: pouring a first resin mixture onto the surface area of the mold to form a first layer of resin product such that the first resin mixture fills the relief areas and partially fills the surface area of the mold; pouring a second resin mixture onto the first layer of resin product to form a second layer of resin product, such that the second resin mixture completely fills the surface area of the mold; pouring a cold cast resin mixture into the relief areas of the mold; allowing the cold cast resin mixture to dry; curing the resin mixture on the mold to form a cold cast resin product; applying an adhesive to a substrate backing to form an adhesive covered substrate; applying the adhesive covered substrate to the resin product; applying pressure to the adhesive covered substrate and the resin product; and removing the warp free decorative article from the mold.

The present invention is further directed to a method of producing a warp free decorative article of manufacture using a mold, wherein the mold includes a surface area further comprising relief areas within the surface area, comprising pouring a first resin mixture onto the surface area of the mold to form a first layer of resin product such that the first resin mixture fills the relief areas of the mold; partially drying the first resin mixture; removing any first resin mixture from the surface area of the mold; pouring a second resin mixture onto the first layer of resin product to form a second layer of resin product, such that the second resin mixture fills the surface area of the mold; drying the products; curing the products on the mold to form a cold cast resin product; applying an adhesive to a substrate backing to form an adhesive covered substrate; applying the adhesive covered substrate to the resin product; applying pressure to the adhesive covered substrate and the resin product; and removing the warp free decorative article from the mold.

The process of the present invention overcomes the deficiencies of prior art articles of manufacture by the application of pressure sensitive adhesive to adhere to the second or first thermosetting layer of resin to the substrate of choice. This process requires no molecular cross-linking to adhere the substrate to cast decorative part, thus not requiring any cure time.

The objects and advantages of the invention will appear more fully from the following detailed description of the preferred embodiment of the invention made in conjunction with the accompanying drawings.

### BRIEF DESCRIPTION OF THE DRAWINGS

FIG. 1 is a perspective view illustrating a mold illustrating the details of the machined cavity of the mold surface.

FIG. 2 is a perspective view of the mold of FIG. 1 illustrating a coating of cold cast resin being applied to the surface of the mold.

FIG. 3 is a perspective view of the mold of FIG. 2 illustrating the cold cast resin curing on the mold surface prior to applying an adhesive-backed substrate.

FIG. 4 is a side view of the mold of FIG. 3 illustrating the application of an adhesive-backed substrate to the out of mold surface of the cold cast resin.

FIG. 5 is a perspective view of the mold of FIG. 4 illustrating the final placement of adhesive-backed substrate to the out of mold surface of the cold cast resin.

FIG. 6 is a side view of the mold of FIG. 5 illustrating placement of the mold within a press for final curing.

FIG. 7 is a perspective view of the finished cold cast article of manufacture illustrating the detailed relief produced from the machined cavity of the mold surface.

### DETAILED DESCRIPTION OF THE INVENTION

### The Mold

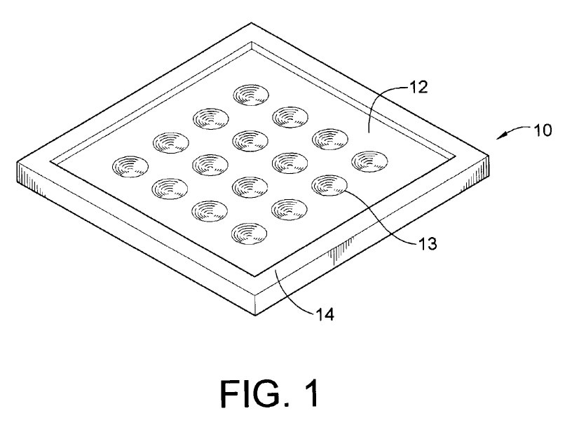

Referring now to the reference numbers in the figures, FIG. 1 shows a mold 10.

Molds 10 utilized in producing articles of manufacture according to the present invention may be made from various materials including, but not limited to polyethylene, including high density polyethylene (HDPE), aluminum, steel, machined steel with Teflon® coating, cast silicone aluminum, silicone or fiberglass composite, and may be cast or machined to produce a decorative pattern generally including a surface area 12 optionally with one or more relief areas 13, as would be known to those skilled in the art. For desired thickness control of the resin on mold 10, an outer frame 14, of higher elevation can be incorporated into mold design. This will also act as a border to retain resin on surface area 12, but is not always necessary.

The mold 10 can be made of silicone that has been cast from a prior known or “found object” with detail. A preferred mold material is Starboard HDPE polyethylene (King Plastics Corp., Venice, Fla.) for machined molds. Silicone S125 material (Synair Corporation, Chattanooga, Tenn.) can be used for cast molds from found objects. The thickness of the molds 10 can vary from 0.125″ (⅛″) to 0.500″ (½″) or more depending on depth of detailed relief cut into the mold. In addition, molds 10 may be formed from flexible material.

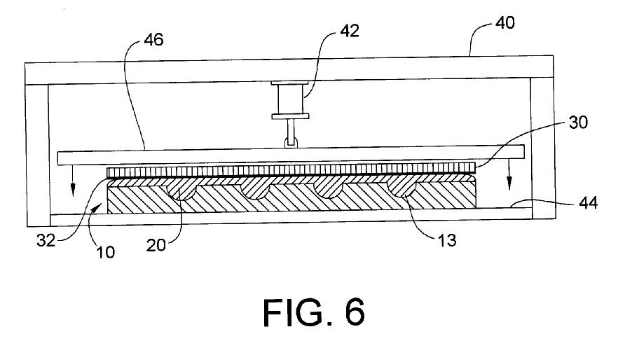

The mold 10 is placed on a mold base or plate (not shown) that can be conveyed into a press 40 as illustrated in FIG. 6. The mold surface must be flat and level.

### The Resin

Although a variety of resin materials may be used in accordance with the present invention, thermosetting resins are preferred. Thermosetting resins such as epoxies, polyurethanes and the like are known to those skilled in the technique of cold casting. The term “thermosetting resin” relates to a polymer that solidifies or “sets” irreversibly on heating. Suitable thermosetting resins include polyesters, epoxies, urethanes, or any other similar resins preferably having various volatile components which cure without releasing solvents and/or gases therein. It is recognized that some polymers although technically “thermoplastics” could be used in the present invention with the proviso that they do not flow under conditions to which the article is typically subjected and the cured resin can be post finished such as via sanding and other operations. Exemplary polymers of this type are the acrylics and vinyls.

The thermosetting resins useful herein can vary and include unsaturated polyesters, phenolics, epoxies, polyurethanes, and the like, and mixtures and blends thereof. The unsaturated polyester resins are a particularly preferred resin. Useful unsaturated polyester resins include practically any esterification product of a polybasic organic acid and a polyhydric alcohol, wherein either the acid or the alcohol, or both, provide the ethylenic unsaturation. Typical unsaturated polyesters are those thermosetting resins made from the esterification of a dihydric alcohol with an ethylenically unsaturated dicarboxylic acid. Examples of useful ethylenically unsaturated polycarboxylic acids include maleic acid, fumaric acid, itaconic acid, dihydromuconic acid, and halo and alkyl derivatives of such acids and anhydrides, and mixtures thereof. Exemplary polyhydric alcohols include saturated polyhydric alcohols such as ethylene glycol, 1,3-propanediol, propylene glycol, 2,3-butanediol, 1,4-butanediol, 2-ethylbutane-1,4-diol, 1,5-pentanediol, 1,6-hexandediol, 1,7-heptanediol, 1,8-octanediol, 1,9-nonanediol, 1,10-decanediol, 2,10-decanediol, 1,4-cyclohexandediol, 1,4-dimethylolcyclohexane, 2,2-diethylpropane-1,3-diol, 2,2-dimethylpropane-1,3-diol, 3-methylpentane-1,4-diol, 2,2-diethylbutane-1,3-diol, 4,5-nonanediol, diethylene glycol, triethylene glycol, dipropylene glycol, glycerol, pentaerythritol, erythritol, sorbitol, mannitol, 1,1,1-trimethylolpropane, trimethylolethane, hydrogenated bisphenol-A and the reaction products of bisphenol-A with ethylene or propylene oxide.

Unsaturated polyester resins can also be derived from the esterification of a saturated polycarboxylic acid or anhydride with an unsaturated polyhydric alcohol. Examples of useful saturated polycarboxylic acids include oxalic acid, malonic acid, succinic acid, methylsuccinic acid, 2,2-dimethylsuccinic acid, 2,3-dimethylsuccinic acid, hexylsuccinic acid, glutaric acid, 2-methylglutaric acid, 3-methylglutaric acid, 2,2-dimethylglutaric acid, 3,3-dimethylglutaric acid, 3-3,-diethylglutaric acid, adipic acid, pimelic acid, suberic acid, azelaic acid, sebaccic acid, phthalic acid, isophthalic acid, terephthalic acid, tetrachlorophthalic acid, tetrabromophthalic acid, tetrahydrophthalic acid, 1,2-hexahydrophthalic acid, 1,3-hexahydrophthalic acid, 1,4-hexahydrophthalic acid, 1,1-cyclobutanedicarboxylic acid and trans-1,4-cyclohexanedicarboxylic acid.

Useful unsaturated polyhydric alcohols for reacting with the saturated polycarboxylic acids include ethylenic unsaturation-containing analogs of the above saturated alcohols (e.g., 2-butene-1,4-diol). The unsaturated polyester resins are generally crosslinked with a compatible crosslinking monomer such as styrene, vinyl toluene, methyl methacrylate, methyl styrene, divinyl benzene, diallyl phthalate and the like.

The amount of polyester thermosetting resin in a resin system used with the present invention may range from about 35 percent to about 100 percent by weight of the total resin system. The amount of crosslinking monomer may be about 10 percent to about 65 percent by weight of the resin system.

The use of a clear, unsaturated polyester resin is desired. This type of resin is the same as that used in the synthetic marble solid surface casting industry. A preferred resin is Reichold's Polylite 32166 solid surface casting resin (Reichold, Research Triangle Park, N.C.).

### Additives

A resin system used in accordance with the present invention can also include various additives commonly employed in thermosetting resin compositions such as fillers, colorants, veining pigments, thixotropic agents, chemical thickening agents, casting part release agents, low profile additives, fiber reinforcement, and other additives for imparting desirable properties such as hardness, color, flame retardancy, aesthetic appearance, smoothness, clarity and the like. Fibers added may include glass, carbon, metals, and the like. Additionally, resins may be selected having a degree of translucency allowing the colors of other resins used to be visible. A variety of desired aesthetic characteristics can be achieved by selecting resins having different colors and properties, as would be understood by those having skill in the art.

### Fillers

Exemplary fillers can include, among others, alumina trihydrate, quartz powder, marble powder, crushed silica, calcium carbonate, clay, glass fibers, powdered metals, mixtures thereof and other mineral and inorganic particulates that contribute to the aesthetics of the final article. The fillers are used in amounts of about 20 to about 300 percent by weight of resin.

### Metal Filler Types

Metal powders come from metals such as bronze, brass, copper, nickel, silver, aluminum, tin, stainless steel, zinc, and others.

A preferred mesh size for cold casting processes is between −325 and −225 for metal powder mixed with casting resin. Coarse metal powder gives a rougher texture and fine metal powder results in a smoother finish. It is within the present invention to consider anything granular or powder into the casting resin such as glass, sand, wood chips, and wood saw dust. Metal powder color can vary between manufacturers. A representative supplier for metal powder is United States Bronze Powders, Inc. (Flemington, N.Y.).

### Pigment

Various colorants and veining pigments can be added for purposes of providing background color and other aesthetically pleasing features to the resin system and molded article. For example, tinting pigments such as titanium dioxide and the like can be added or a trace amount of carbon black can be swirled in to contribute to the marble-like appearance. The amount used is typically less than about 3 percent by weight.

Alternatively to a metal finish, a pigment can be added to the resin of choice for a solid color or two color panel. When pigment is used, then viscosity must be increased by filling the resin with fillers known in the cold casting industry.

According to the present invention, coloring pigmentation is preferably added to and mixed thoroughly with the thermosetting resin prior to curing. As a result, the respective color of the resin extends throughout the resin. Accordingly, if a portion of the relief was removed as a result of chipping or wear, the remaining portions would still have the same color, unlike conventional display articles wherein the color is added to an outer layer thereof. A preferred pigment is distributed by Caddo Paint (Shreveport, La.).

### Fillers and Thixotropic Fillers

The preparation of curable thermosetting resins is well known in the art and generally involves mixing resins with various filler materials, fiber reinforcement, appropriate catalysts, and desired tinting or pigment materials, referred to as a resin system. Preferred filler materials, such as alumina and/or glass fibers, are selected to impart desired properties to a thermosetting resin.

A preferred filler is aluminum trihydrate (ATH) (R.J. Marshall Co., Southfield, Mich.). Adding fillers to the pigmented resin helps decrease the shrinking of the resin due to the curing process of the polyester resin. Cabosil (fumed silica) (Cabot Corporation, Tuscola, Ill.), known as a thixotropic agent filler, is used more for the purpose of thickening viscosity and not actually filling resin to decrease shrinkage.

Thixotropic agents are agents which cause the viscosity of the resin system to vary as a function of its state of agitation and the previous history of motion within the fluid. These agents are preferably used to maintain the filler and other additives in suspension while the resin is curing. Generally, the viscosity of a thixotropic fluid decreases as its state of agitation and length of agitation increases, and increases as its state of agitation and length of agitation decreases. An exemplary thixotropic agents is fumed silica. The amount used is typically less than about 1 percent by weight.

### Resin and Metal Powder Ratios

Mixing metal powder and resin together requires knowledge of the ratio of resin to metal needed. A good starting point is 1:1 or 50/50 mix of each by volume. Less metal may be desired or needed. Many variables can affect this decision such as cost, appearance, more shrink due to less metal as filler, depth of relief in mold and over all thickness desired. Preferred formulae are prepared by weight and not by volume once the desired formula is obtained. For example, a bronze part might be cast with a formula ratio of 1.5:1 (1.5 bronze and 1 part resin). This ratio by weight is well below 1:1 (50/50) by volume, but it may be all that was needed to achieve the desired look and quality.

### Mixing Resins, Fillers, Metal Powders and Initiators

Mixing the metal fillers or pigment with ATH filler in the clear unsaturated polyester solid surface casting resin should be done while mixing action is occurring, pouring in the metal fillers or pigment/ATH filled fillers slowly to avoid clumping. As the batch is mixed, an initiator (sometimes called a catalyst or hardener) is added. Exemplary room temperature-free radical initiators include hydrogen peroxide and methyl ethyl ketone peroxide (MEKP) noting that most commercially available MEKP includes some hydrogen peroxide. Exemplary peroxy-type free radical polymerization initiators are the hydroperoxides such as tert-butyl hydroperoxide, 2,5-dimethylhexane-2,5-dihydroperoxide, cumene hydroperoxide, para-methane hydroperoxide and the like; peroxy esters such as di-tert-butyl peroxide, dibenzyl peroxide and the like; ketone peroxides such as methyl ethyl ketone peroxide, cyclohexanone peroxide and the like; acyl peroxides such as benzoyl peroxide, parachlorobenzoyl peroxide; 2,4-dichlorobenzoyl peroxide, lauroyl peroxide and the like. Also azo promoters such as azobisbutrylnitrile can be used. The amount of first and second curing agents used is dependent on the time desired for thermosetting, but is typically a short period of time (i.e., less than 3 hours, typically less than 2 hours and often less than 1 hour). The amount used is about 0.01 to about 0.1 percent by weight of the first curing agent and about 0.1 to about 5 percent by weight of the second curing agent.

The preferred initiator is Luperox DDM-9 (Arkema Inc., Philadelphia, Pa.). This should be used at a ratio which is recommended by the clear unsaturated casting resin manufacturer. A typical range would be 1 to about 5 percent weight of the resin. This is mixed with the resin and metal powder or resin, pigment, and ATH filled batch in a manner known to the art to afford enough time to pour the mixture on to the surface 12 of the mold 10.

### Steps

### 1. Prepare Mold 10

The mold 10 should be clean and free of any foreign material. Prior to dispensing a resin 16 onto the mold 10, a release coating (not shown) should be applied to the mold 10. There are a number of release agents that can be used for mold release and work very well under certain circumstances. Exemplary release agents include, but are not limited to, silicon release agents, wax in the carnauba wax family, TEFLON, (a trademark of the E.I. DuPont de Nemours Company, Wilmington, Del.), zinc stearate, or any similar material which will function as a release agent for the particular resin material being used to create the decorative article, the selection of which is within the skill of one in the art. A preferred mold release agent is a silicone-based mold release made by H+K Research Corp. (Hickory, N.C.). Silicone can be wiped on the mold surface to prevent the sticking of cold cast resin panel while demolding from mold surface and detailed relief area that has been cut into the mold surface 12.

### 2. Pour Cold Cast Resin and Metal Mix 16 onto the Mold 10

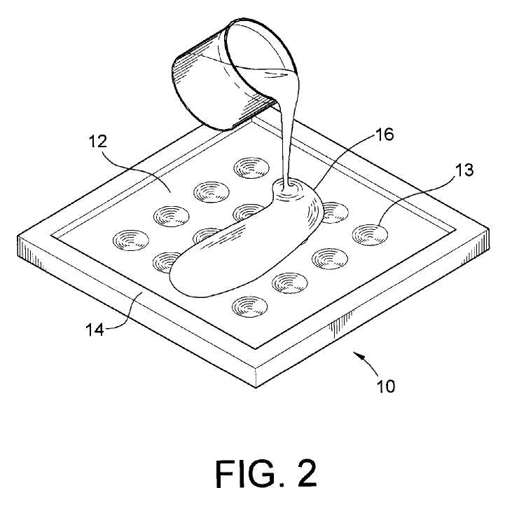

Referring now to FIG. 2, the cold cast resin mixture 16 can be poured directly onto the surface area 12 of the mold 10 such that the resin mixture 16 fills the entire surface area 12 including the relief areas 13. Without wishing to be limited to the type of application, it appears that pouring the resin mixture 16 in the center of the mold 10 results in a superior application. The resin mixture 16 should then be immediately spread over the entire surface area 12 of the mold 10. This can be accomplished by any means known to the art such as a brush, paint roller, or a sheet rock type spatula (not shown). In this regard, reference is made to U.S. Pat. No. 6,238,609 to Stecker which is incorporated herein by reference to describe the manner of application of a resin 16 to the surface of a mold 10.

The thickness of the resin mixture 16 sitting on the surface area 12 of the mold 10 depends of the nature and potential use of the final article of manufacture. Without wishing to be bound to a specific thickness, it is generally agreed that a surface thickness, including the relief, of 0.0625″ to 0.250″ ( 1/16″ to ¼″) is a preferred range for the adhesive bonded casting process of the present invention. The thickness specified appears to give the cast article of manufacture a desired surface integrity and enhanced durability for high traffic area installations. The specified thickness also hides blemishes in the out of mold surface that would otherwise transfer to the face of the cast article of manufacture during the application of adhesive covered substrate under pressure.

The cold cast resin mixture 16 on the surface area 12 of the mold 10 should be allowed to dry to the touch, i.e., a mark will not be left on the out of mold surface 18 of the hardened resin product 20. This is usually 30 to 45 minutes.

It is also noted that the cold cast resin mixture 16 can be applied in two layers. For example if the cost of an ingredient in the resin mixture 16, e.g. the metal powder, is an issue, a thinner layer of the resin mixture 16 with the metal powder can first be applied such that it fills the relief areas 13 and part of the surface area 12 of the mold 10. The a back-fill layer of ATH/resin can be added on top of the first layer of metal/resin so as to build up the thickness on the surface area 12 of the mold 10 to achieve the recommended total thickness as stated previously.

It is also within the scope of the present invention to cast a resin product with two colors. Two color cast articles of manufacture are a little different than a single color casting as described above and are described in Stecker. The first color is poured as a first layer only in the relief areas 13 while avoiding the surface area 12 of the mold 10 similar to that described above for a single color casting but with less quantity of casting material. The first layer resin mixture is poured into the center of the mold 10 and immediately brushed, rolled, or spread with a spatula to a very thin casting over the entire surface of the mold 10 such that all the relief areas 13. A sheet rock spatula is preferred to spread the casting mixture because the other methods described will sometime pull the casting mixture out of the relief areas 13.

After the first layer has been poured and spread onto the relief areas 13, the remaining resin material is removed from the surface area 12 of the mold 10 leaving only the cast resin mixture in the relief areas 13 in the mold 10. This is preferably accomplished by using a wide, hard, rubber squeegee to scrape off the thin layer of cast resin from surface area 12 leaving only cast resin in the relief areas 13 cut in the mold 10.

The resin left in the relief areas 13 in the mold 10 is left to dry to the point that it is tacky to touch, approximately 15-20 minutes. Any remaining resin residue on the surface area 12 is then removed in a timely manner, so as not to let the cast resin left in the relief areas 13 dry fully as the resin may shrink, causing what is known as a “bleed through,” which is the leaking of the second layer of resin past, and into the first layer of resin sitting in the relief areas 13 in the mold 10.

Removal of cast resin residue from surface area 12 can be accomplished by means known to the art. For example, saturating a terry cloth rag with acetone, wiping the rag across ⅓ of one side of the mold surface twice, and on the second pass of wiping the surface, followed behind that saturated rag with a dry rag will work. Then, the process is moved onto the next ⅓ of the mold and repeated. Preferably, the acetone is not left on the surface too long which may cause bleeding past the first pass of resin in the relief. After cleaning the one side, the other side is similarly cleaned.

Following the thorough cleaning process, the second resin layer is applied to the surface area 12 in a manner similar to that described above.

### 3. Cure the Cold Cast Resin Product 20 on the Mold 10

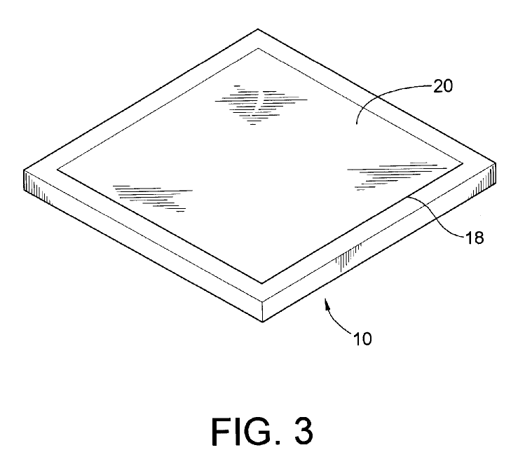

Reference is now made to FIG. 3 which illustrates the cold cast resin product 20 curing on the surface area 12 of the mold 10 prior to applying an adhesive backed substrate.

### 4. Apply Pressure Sensitive Adhesive Liner 32 to Substrate 30

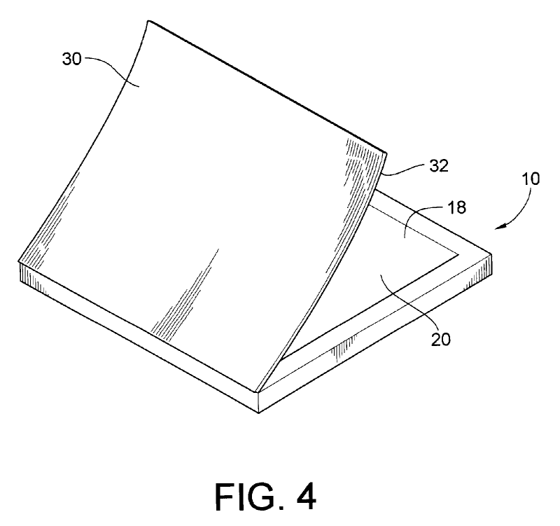

Referring to FIG. 4, the substrate 30 is a stiff board which provides a backing for the cold cast resin product 20. Aluminum is typically the substrate backer of choice. However, other materials such as medium density fiberboard (MDF), wood, plywood, laminates and other substrates that lend themselves to pressure sensitive closed cell or open cell adhesive adhesion, can be used and are pre-applied with a closed cell or open cell foam pressure sensitive adhesive 32. This is accomplished by an adhesive laminating machine known to the art. The process is also a known technique in the adhesive industry. There are many types of open cell and closed cell foam pressure sensitive adhesives and manufacturers of such. Foam pressure sensitive adhesive are known to the industry. Representative manufacturers include, but not limited to, Northern Engraving Corp. (Sparta, Wis.), 3M Corporation (St. Paul, Minn.), Avery Denison (Brea, Calif.), Saint Gobain (Granville, N.Y.), and Tekra Corporation (New Berlin, Wis.). A preferred foam pressure sensitive adhesive is product 8292-H2 manufactured by Northern Engraving Corporation.

The pressure sensitive adhesive 32 typically has an adhesive liner (not shown) to protect the adhesive. Prior to applying the substrate 30 to the cold cast resin product 20, the adhesive liner of the pressure sensitive adhesive 32 is removed.

### 5. Apply Pressure Sensitive Adhesive 32 Covered Substrate 30 to the Out of Mold Surface 18 of the Cold Cast Resin 20

Referring again to FIG. 4, after the cold cast resin product 20 has been allowed to cure, the adhesive covered substrate 30 is applied to the out of mold surface 18 of the cold cast resin product 20. Application of the substrate 30 with the pressure sensitive adhesive 32 is then bonded to the out of mold surface 18 of the cold cast resin product 20 while the cold cast resin product 20 is still in the mold 10. This is accomplished in a progressive manner as not to trap air between adhesive covered substrate 30 and out of mold surface 18 of the cold cast resin product 20.

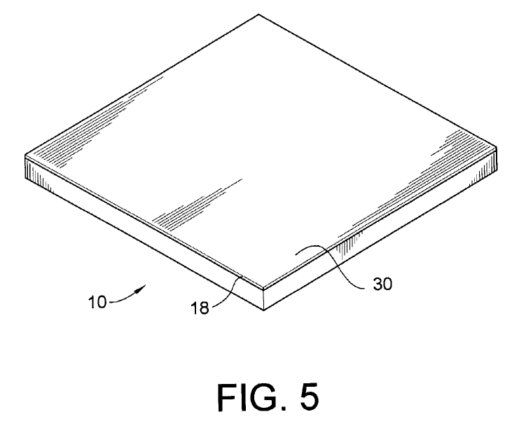

FIG. 4 is a perspective view illustrating the first stage of the molding process where the application of substrate 30 with the pressure sensitive adhesive 32 pre-applied is bonded to the out of mold surface 18 of the cold cast resin product 20 while the resin product 20 is still in the cavity side of the mold 10. This is done in a progressive manner as not to trap air between adhesive covered substrate 30 and out of mold surface 18 of the resin product 20 until the entire surface area of the substrate 30 is bonded to the resin product 20 as illustrated in FIG. 5.

### 6. Pressing the Substrate 30 and the Resin Product 20 Together

Referring now to FIG. 6, the cold cast resin product 20 which has now been bonded to the substrate 30 is then conveyed into a flat press 40 and pressure is then applied to the complete package as a whole to achieve intimate contact between pressure sensitive adhesive 32, the substrate 30, and the cold cast resin product 20. It is within the scope of the present invention to use any of a number of presses as long as press provides equal pressure along the full surface area of the substrate 30. As illustrated in FIG. 6, a representative press 40 can be an air or hydraulic press with a press ram 42, a press platen 44, and a press pressure transfer plate 46, which covers the surface of the substrate 30. Preferably, pressure is applied between 1 and 5 minutes.

### 7. Adhesive Bonded Cold Cast Product 20 Finishing

The cold cast product 20 should cure for 24 to 48 hours at room temperature. After the product 20 is cured it can be polished. Polishing can be accomplished with techniques known to those familiar in the polishing of cast metal business. After polishing, the product 20 can be washed to remove any residue from polishing compound. The cold cast resin product 20 can then be top coated or painted if desired and trimmed or cut to desired size.

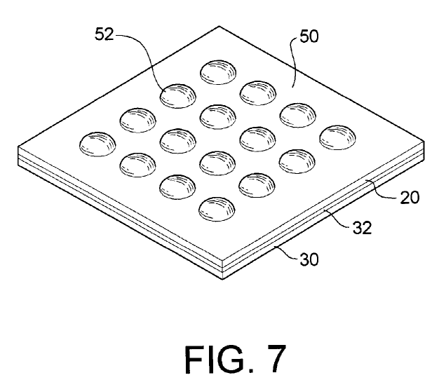

FIG. 7 illustrates the demolded cold cast product 20 with aluminum substrate 30 backer bonded to the out of mold surface 18 of the resin product 20. As illustrated in FIG. 7, the surface 50 of the demolded resin product 20 show the detailed relief 52 produced from relief areas 13 in the surface area 12 of the mold 10.

It is understood that the invention is not confined to the particular construction and arrangement of parts herein illustrated and described, but embraces such modified forms thereof as come within the scope of the following claims.

What is claimed is:

1. A method of producing a warp free decorative article of manufacture using a mold, wherein the mold includes a surface area further comprising relief areas within the surface area, comprising:
a. pouring a cold cast resin mixture into the surface area of the mold;
b. allowing the cold cast resin mixture to dry;
c. curing the resin mixture on the mold to form a cold cast resin product;
d. applying an adhesive to a substrate backing to form an adhesive covered substrate;
e. applying the adhesive covered substrate to the resin product;
f. applying pressure to the adhesive covered substrate and the resin product; and
g. removing the warp free decorative article from the mold.

2. The method of claim 1 further comprising adding a release coating to the surface area.

3. The method of claim 2 wherein the release coating is selected from the group consisting of silicon release agents, wax in the carnauba wax family, TEFLON, and zinc stearate.

4. The method of claim 1 wherein the mold is made materials selected from the group consisting of polyethylene, high density polyethylene, aluminum, steel, machined steel with TEFLON coating, cast silicone aluminum, silicone and fiberglass composite.

5. The method of claim 1 wherein the surface area of the mold has a depth between about 0.125″ (⅛″) and 0.500″ (½″).

6. The method of claim 1 wherein the cold cast resin mixture includes a thermosetting resin.

7. The method of claim 6 wherein the thermosetting resin is selected from the group consisting of polyesters, phenolics, epoxies, polyurethanes, urethanes, acrylics and vinyls.

8. The method of claim 6 wherein the resin is a clear, unsaturated polyester resin.

9. The method of claim 1 wherein the cold cast resin mixture includes additives selected from the group consisting of fillers, colorants, veining pigments, thixotropic agents, chemical thickening agents, casting part release agents, low profile additives, fiber reinforcement, and other additives for imparting desirable properties such as hardness, color, flame retardancy, aesthetic appearance, smoothness, and clarity.

10. The method of claim 9 wherein the fillers are selected from the group consisting of alumina trihydrate, quartz powder, marble powder, crushed silica, calcium carbonate, clay, glass fibers, powdered metals, and mixtures thereof.

11. The method of claim 9 wherein the fillers are present in the resin mixture in amounts between about 20 and about 300 percent by weight of the resin.

12. The method of claim 6 wherein the metal powders are selected from the group consisting of bronze, brass, copper, nickel, silver, aluminum, tin, stainless steel and zinc.

13. The method of claim 6 wherein the metal powders are present in the resin mixture in a size between about −325 and −225 mesh.

14. The method of claim 6 wherein the ratio of metal powder to resin in the resin mixture is 1:1.

15. The method of claim 1 wherein the substrate backing material is selected from the group consisting of aluminum, medium density fiberboard, wood, plywood, and laminates.

16. The method of claim 1 wherein the adhesive is selected from a closed cell or open cell foam pressure adhesive.

17. The method of claim 1 wherein the adhesive includes a liner.

18. The method of claim 17 further comprising removing the liner prior to applying the substrate backing to the resin product.

19. The method of claim 1 further comprising applying the adhesive covered substrate to the cold cast resin product in the absence of air.

20. The method of claim 1 further comprising applying pressure by a flat press.

21. The method of claim 20 wherein the flat press is selected from a hydraulic or an air press.

22. The method of claim 20 wherein the flat press applies equal pressure along the full surface area of the substrate.

23. The method of claim 1 wherein pressure is applied for a period between 1 and 5 minutes.

24. A method of producing a warp free decorative article of manufacture using a mold, wherein the mold includes a surface area further comprising relief areas within the surface area, comprising:
a. pouring a first resin mixture onto the surface area of the mold to form a first layer of resin product such that the first resin mixture fills the relief areas and partially fills the surface area of the mold;
b. pouring a second resin mixture onto the first layer of resin product to form a second layer of resin product, such that the second resin mixture completely fills the surface area of the mold;
c. pouring a cold cast resin mixture into the relief areas of the mold;
d. allowing the cold cast resin mixture to dry;
e. curing the resin mixture on the mold to form a cold cast resin product;
f. applying an adhesive to a substrate backing to form an adhesive covered substrate;
g. applying the adhesive covered substrate to the resin product;
h. applying pressure to the adhesive covered substrate and the resin product; and
i. removing the warp free decorative article from the mold.

25. The method of claim 24 wherein the first resin mixture includes an additive.

26. The method of claim 24 wherein the thickness of the combined first layer of resin product and second layer of resin product is between 0.0625 and 0.250 inches.

27. A method of producing a warp free decorative article of manufacture using a mold, wherein the mold includes a surface area further comprising relief areas within the surface area, comprising:
a. pouring a first resin mixture onto the surface area of the mold to form a first layer of resin product such that the first resin mixture fills the relief areas of the mold;
b. partially drying the first resin mixture;
c. removing any first resin mixture from the surface area of the mold;
d. pouring a second resin mixture onto the first layer of resin product to form a second layer of resin product, such that the second resin mixture fills the surface area of the mold;
e. drying the products of steps a-d;
f. curing the products of steps a-d on the mold to form a cold cast resin product;
g. applying an adhesive to a substrate backing to form an adhesive covered substrate;
h. applying the adhesive covered substrate to the resin product;
i. applying pressure to the adhesive covered substrate and the resin product; and
j. removing the warp free decorative article from the mold.

28. The method of claim 27 wherein the total thickness of the combined first layer of resin product and second layer of resin product is between 0.0625 and 0.250 inches.

29. The method of claim 27 wherein the first resin mixture is a different color than the second resin mixture.
